(19) United States
(12) Patent Application Publication
(10) Pub. No.: US 2011/0051152 A1
(43) Pub. Date: Mar. 3, 2011

(54) Image Processing Apparatus, Image Processing Method, And Program

(75) Inventors: Masaki Nakayama, Nagano-ken (JP); Yoichiro Maki, Nagano-ken (JP)

(73) Assignee: Seiko Epson Corporation, Tokyo (JP)

(21) Appl. No.: 12/873,716

(22) Filed: Sep. 1, 2010

(30) Foreign Application Priority Data
Sep. 2, 2009 (JP) 2009-202840

(51) Int. Cl. G06F 15/00

(52) U.S. Cl. 358/1.5

(57) ABSTRACT

An image processing apparatus includes: a reading unit; a counting unit; a cumulative value calculation unit; a cumulative value storing unit; and a print range determination unit, wherein the cumulative value calculation unit sets a value obtained by subtracting a predetermined value from the cumulative value, as the cumulative value, in the case where the number of pixels having a luminance equal to or smaller than a predetermined luminance value is not counted by the counting unit.

### CROSS-REFERENCE TO RELATED APPLICATION(S)

Japanese Patent Application No. 2009-202840, filed Sep. 2, 2009, is hereby incorporated by reference in its entirety.

### BACKGROUND

1. Field of Invention

The present invention relates to an image processing apparatus, an image processing method, and a program.

2. Description of Related Art

There is known in the art an ink jet multifunction peripheral capable of removing noise existing in the areas other than a print range by determining (modifying) the print range (e.g., JP-A-2008-188936). Using such an apparatus, it is possible to promote a high speed print processing by omitting extra operations for printing noise data located outside the print range.

In such an ink jet multifunction peripheral, a cumulative histogram of the print pixel number is created on a band-by-band basis for the image data read from the original. Using a histogram of three bands in addition to a cumulative histogram of upper and lower bands, examination is performed from an end of the band to a position where the cumulative value of a print pixel number reaches a particular threshold value, and a boundary of the print range is determined (modified) based on that position.

However, the noise data to be removed has a smaller number of pixels in comparison with the print data to be printed. In addition, it is difficult to determine whether the noise data located near the print data to be printed is the print data to be printed or the noise data.

For this reason, in the related art, the removable noise data is limited to the case where the pixel number is sufficiently small and those isolated from the print data to be printed. As a result, in the related art, the noise data concentrated in a portion thereof are not removed, and an extra operation occurs during the print processing.

### SUMMARY OF INVENTION

An advantage of some aspects of the invention is to provide a technique of removing noise data from the image data to be printed with better precision than that of the related art.

According to an aspect of the invention, there is provided an image processing apparatus including: a reading unit that reads image data; a counting unit that counts a number of pixels having a luminance equal to or smaller than a predetermined luminance value at each position in a main scanning direction for the image data of a predetermined number of bands read by the reading unit; a cumulative value calculation unit that accumulates the number of pixels counted by the counting unit at each position of the main scanning direction; a cumulative value storing unit that stores the cumulative value accumulated by the cumulative value calculation unit; and a print range determination unit that determines a print start position based on a position where the cumulative value exceeds a predetermined threshold value, wherein the cumulative value calculation unit sets a value obtained by subtracting a predetermined value from the cumulative value, as the cumulative value, in the case where the number of pixels having a luminance equal to or smaller than a predetermined luminance value is not counted by the counting unit.

### BRIEF DESCRIPTION OF THE DRAWINGS

The invention will be described with reference to the accompanying drawings, wherein like numbers reference like elements.

FIG. 1 is a schematic functional block diagram illustrating an image processing apparatus according to an embodiment of the invention.

FIG. 2 is a functional block diagram illustrating an image processing apparatus.

FIG. 3 illustrates an analysis range of the image data.

FIG. 4 is a flowchart illustrating a noise removal process according to a first embodiment.

FIG. 5 illustrates an exemplary histogram created according to a first embodiment.

FIG. 6 is a schematic diagram illustrating a print operation.

FIG. 7 is a flowchart illustrating a noise removal process according to a second embodiment.

FIG. 8 illustrates an exemplary histogram created according to a second embodiment.

### DESCRIPTION OF THE PREFERRED EMBODIMENTS

### First Embodiment

Hereinafter, embodiments of the invention will be described with reference to the accompanying drawings.

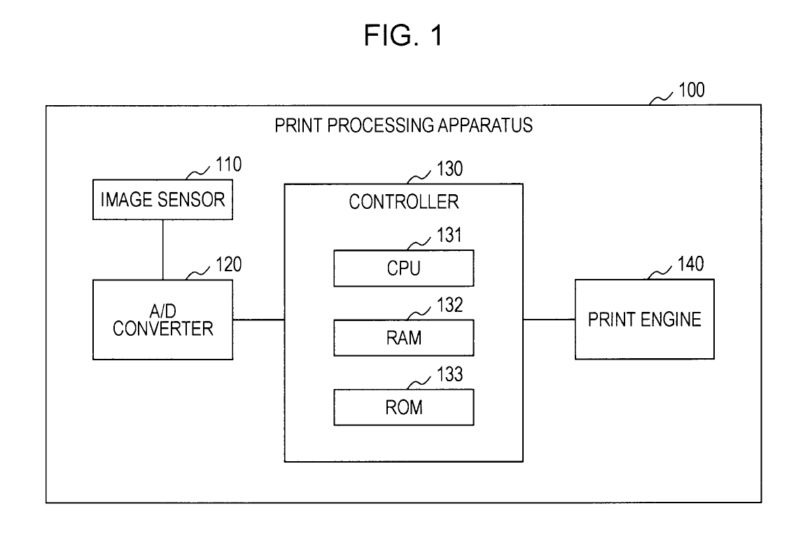

FIG. 1 is a schematic block diagram illustrating an image processing apparatus 100 according to an embodiment of the invention.

The image processing apparatus 100 is, for example, a multifunction peripheral or a copy machine. The image processing apparatus 100 includes an image sensor 110, an A/D converter 120, a controller 130, and a print engine 140 as shown in the drawing.

The image sensor 110 outputs the read signal (analog data representing luminance values of each color of red, green, and blue (RGB)) from the original or the like to the A/D converter 120. Specifically, the image sensor 110 receives the light reflected by the original or the like and reads the cumulative electric charges as a voltage depending on the received light amount to output it to the A/D converter 120.

The A/D converter 120 converts (quantizes) the analog data (read signal) output from the image sensor 110 into digital data and outputs it to the controller 130.

The controller 130 includes a chip (SoC) or the like having the main functions of the image processing apparatus 130 to perform control of the entire image processing apparatus 130. For example, the controller 130 obtains the image data (digital data) output from the A/D converter 120 on a band-by-band basis. In addition, the controller 130 generates a histogram for the obtained image data on a band-by-band basis and performs analysis. Furthermore, the controller 130 determines a print range based on the result of the analysis. The controller 130 converts the obtained image data into print data that can be printed and outputs it to the print engine 130. Moreover, the controller 130 performs control of the print head (not shown) such that the print is effectively made within the determined print range.

In order to realize the aforementioned processes, the controller 130 includes a CPU (Central Processing Unit) 131, a RAM (Random Access Memory) 132, and a ROM (Read Only Memory) 133 as shown in the drawings. The controller 130 may include an ASIC exclusively designed to perform the aforementioned processes.

The CPU 131 executes various programs. The RAM 132 temporarily stores various data such as the image data read from the image sensor 110 and programs. The ROM 133 is stored in advance with various data, various programs, or the like for controlling the image processing apparatus 100 in a non-volatile manner.

The print engine 140 performs print (such as a print process) of the print data output from the controller 130 based on instructions (control signals) from the controller 130.

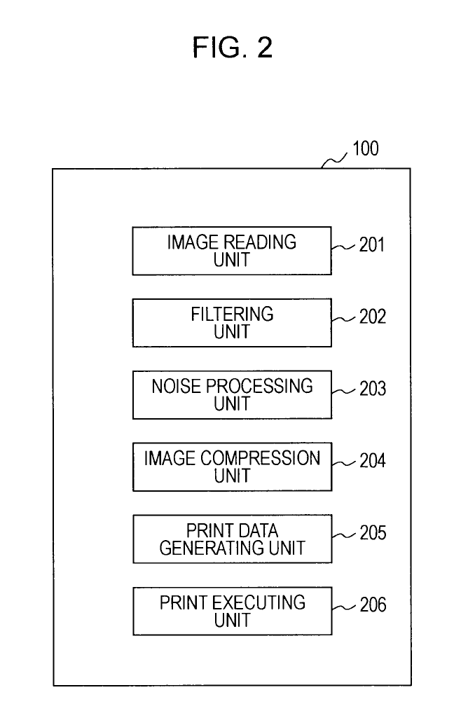

FIG. 2 is a block diagram illustrating an image processing apparatus 100. As shown in the drawing, the image processing apparatus 100 includes an image reading unit 201, a filtering unit 202, a noise processing unit 203, an image compression unit 204, a print data generating unit 205, and a print executing unit 206.

The image reading unit 201 performs reading of the image data. For example, the image reading unit 201 performs control of a movement amount or speed of a carriage (not shown) by performing control of the rotation amount or speed of a motor for driving the carriage. In addition, the image reading unit 201 supplies the image sensor 110 with a shift pulse for operating the image sensor 110 and outputs the read signal (analog data) depending on the electric charge amount accumulated in the image sensor (photoelectrical converter element) 110 to the A/D converter 120 at a predetermined timing. Furthermore, the image reading unit 201 obtains the image data converted into the digital data from the read signal (analog data) by the A/D converter 120 on a band-by-band basis and stores it in a memory (e.g., the RAM 132).

The filtering unit 202 performs processes such as pixel correction, gamma correction, color space conversion, or color suppression for the image data obtained by the image reading unit 201.

The noise processing unit 203 performs a process for removing noise from the image data processed by the filtering unit 202.

Specifically, the noise processing unit 203 creates a cumulative histogram of the print pixel number using image data corresponding to a predetermined number of bands (e.g., three bands).

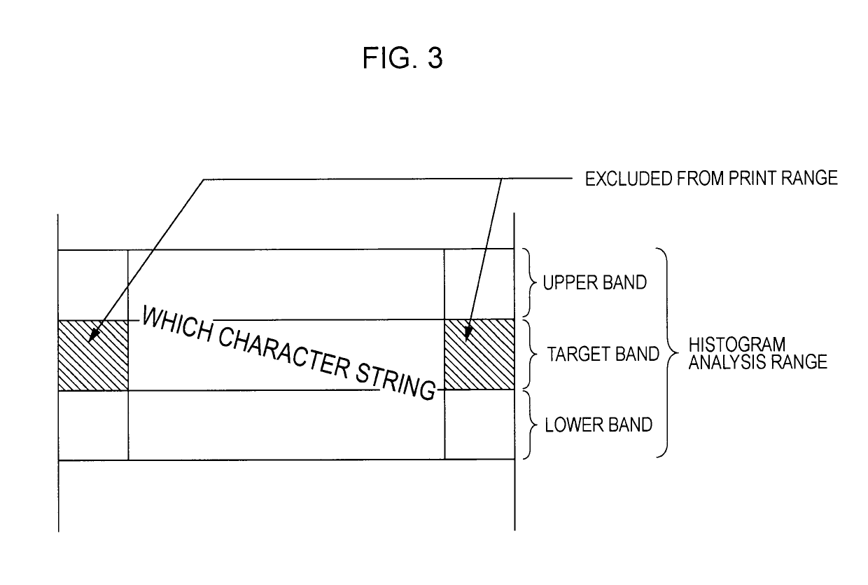

FIG. 3 illustrates an analysis range (the range used to create the cumulative histogram) of the image data. As shown in the drawing, in the present embodiment, the image data corresponding to three bands is used as the analysis range. In other words, when the cumulative histogram is created for the image data of a single band to be analyzed (hereinafter, referred to as a target band), three bands of the image data including the target band itself, a band over the target band (hereinafter, referred to as an upper band), and a band under the target band (hereinafter, referred to as a lower band) are used as the analysis range.

The noise processing unit 203 specifies the position where the cumulative value of the print pixel number reaches a particular threshold value from an end of the band (left and right ends) using the created cumulative histogram and determines the boundary of the print range based on that position. As a result, the data (noise data) out of the print range (the hatched portion shown in FIG. 3) is not printed. In addition, a detailed process (the analysis process) performed by the noise processing unit 203 will be described in detail below.

The image compression unit 204 compresses the image data for the process of removing the noise and stores it in the storage medium such as an image buffer. For example, the JPEG may be used as the compression method.

The print data generating unit 205 reads the image data compressed by the image compression unit 204 from the storage medium and decompresses it so as to generate print data that can be printed by the print engine 140. Then, the print data generating unit 205 transmits a print command for controlling the print engine 140 and the generated print data to the print engine 140 to perform printing.

The print executing unit 206 prints the print data output from the controller 130. Specifically, the print executing unit 206 performs control of the print engine 140 or the print head (not shown) depending on the received print command to perform the print process as it receives the print command together with the print data.

The image processing apparatus 100 according to an embodiment of the invention has the aforementioned configuration. However, the configuration of the image processing apparatus 100 is not limited thereto. For example, the image processing apparatus 100 may be a multifunction peripheral additionally having a facsimile function or the like.

The aforementioned elements are classified depending on their processing functions in order to facilitate understanding of the configuration of the image processing apparatus 100. The invention is not limited to the method of classifying the elements or their names. The configuration of the image processing apparatus 100 may be classified into more elements depending on the processing functions. In addition, a single element may be classified to execute yet more processes. The processes in each element may be executed in a single piece of hardware or a plurality of pieces of hardware.

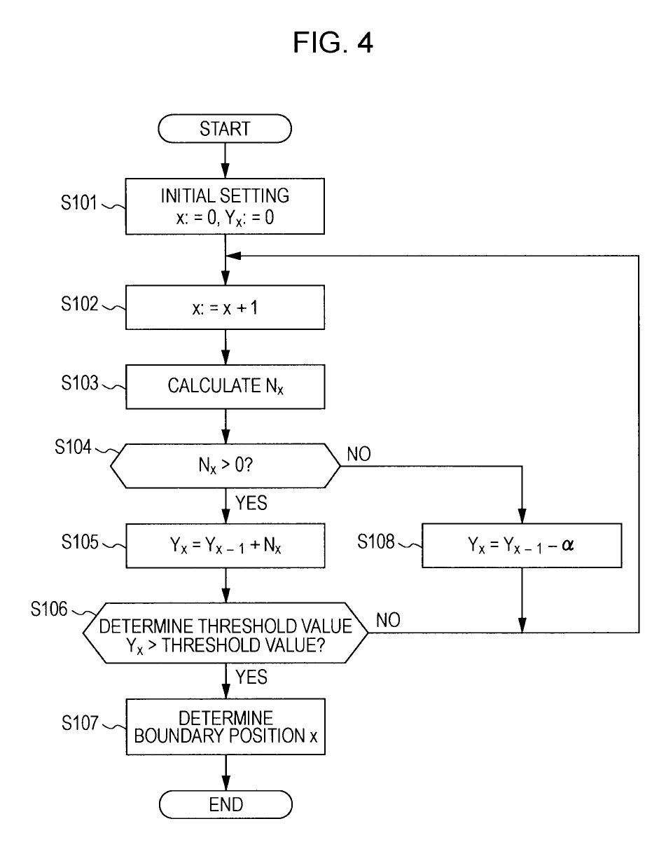

Next, particular operations of the image processing apparatus 100 having the aforementioned configuration will be described. FIG. 4 is a flowchart illustrating a noise removal process according to an embodiment of the invention.

For example, the noise processing unit 203 initiates the present flow, for example, for the image data read by the image reading unit 201 as the process of the filter unit 202 is terminated.

As the present flow is initiated, the noise processing unit 203 performs initial setting (step S101). Specifically, the noise processing unit 203 reads the image data of the target band, the upper band, and the lower band from the memory (e.g., the RAM 132). The noise processing unit 203 sets the target pixel position for counting the print pixels (the pixels having a luminance value equal to or smaller than a predetermined value) to an initial position (x=0) and also sets the cumulative print pixel number to an initial value (Y_{X}=0).

Next, the noise processing unit 203 shifts by one the position x of the accumulation target pixel in the main scanning direction (e.g., the forward direction to the main scanning direction) (step S102). Specifically, the noise processing unit 203 increments the position of the accumulation target pixel. As a result, in the case where step S102 is initially performed after the present flow is initiated, the position x of the accumulation target pixel becomes the position (x=1) of the pixel located in the left end of the band (the pixel to be printed in the left end of the print medium).

The noise processing unit 203 calculates the print pixel number N_{X} existing in the pixel position x for the image data of the three bands (the target band, the upper band, and the lower band) (step S103). Specifically, the noise processing unit 203 counts the number of pixels that exist in the position x of the accumulation target pixel determined in step S102 and have a luminance value equal to or smaller than a predetermined value.

Then, the noise processing unit 203 determines whether or not the print pixel number N_{X} calculated in step S103 is larger than 0 (step S104).

If it is determined that the print pixel number N_{X} calculated in step S103 is larger than 0 in step S104 (YES in step S104), the noise processing unit 203 advances the process to step S105.

As the process advances to step S105, the noise processing unit 203 adds the print pixel number N_{X} calculated in step S103 to the cumulative print pixel number (a cumulative value at the pixel positions from 1 to x−1) Y_{X}−1 at that time point and sets that value as the cumulative print pixel number Y_{X} accumulated in the pixel position x (step S105). In other words, the noise processing unit 203 performs calculation of the equation “Y_{X}=Y_{X-1}+N_{X}.”

Then, the noise processing unit 203 performs threshold value determination for the cumulative print pixel number Y_{X} from the left end of the band to the pixel position x (step S106). Specifically, the noise processing unit 203 determines whether or not the cumulative print pixel number Y_{X} calculated in step S105 exceeds a predetermined threshold value.

It is determined that the cumulative print pixel number Y_{X} does not exceed a predetermined threshold value (NO in step S106), the noise processing unit 203 returns the process to step S102 and repeatedly performs the process from steps S102 to S106 and step S108 until the cumulative print pixel number Y_{X} exceeds a predetermined threshold value.

Meanwhile, if it is determined that the print pixel number N_{X} calculated in step S103 is zero (N_{X}=0) in step S104 (NO in step S104), the noise processing unit 203 advances the process to step S108.

As the process advances to step S108, the noise processing unit 203 sets a value obtained by subtracting a predetermined value α from the cumulative print pixel number Y_{X-1} (the cumulative value at the pixel positions from 1 to x−1) at that time point as the cumulative print pixel number Y_{X} accumulated in the pixel position x (step S108). In other words, the noise processing unit 203 performs calculation of the equation “Y_{X}=Y_{X-1}−α.”

Then, returning the process to step S102, the noise processing unit 203 repeatedly performs the process of steps S102 to 5106 and step S108 until the cumulative print pixel number Y_{X} exceeds a predetermined threshold value.

The aforementioned cumulative histogram can be created by calculating the cumulative print pixel number Y_{X} for each pixel position x by repeating the aforementioned process of steps S102 to S106 and step S108.

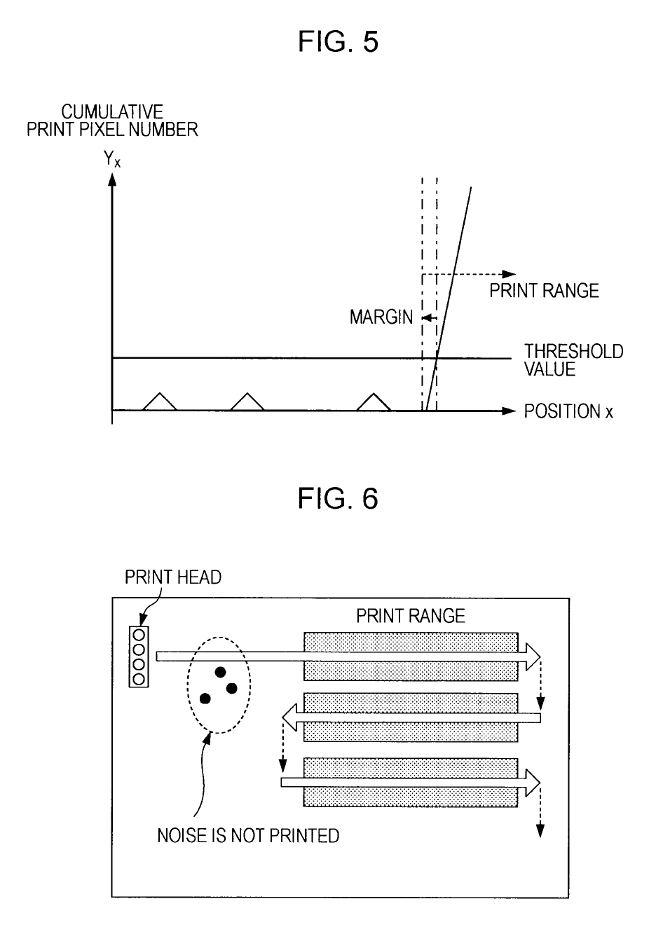

FIG. 5 illustrates an exemplary cumulative histogram created by the noise processing unit 203 according to an embodiment of the invention. In the cumulative histogram illustrated in the drawing, the abscissa denotes the pixel position x, and the ordinate denotes the cumulative print pixel number Y_{X} (a cumulative value). As recognized from the illustrated example, as the pixel position x increases, the cumulative print pixel number Y_{X} does not proportionally increase (it is not an ever-increasing graph), but the cumulative print pixel number Y_{X} repeatedly increases and decreases. This is because, when the print pixel number N_{X} at the pixel position x is zero, the cumulative print pixel number Y_{X} decreases in step S108 (Y_{X}=Y_{X-1}−α). As a result, when the print pixels are not consecutively provided in a positional relationship, they may be regarded as noise data and may not be accumulated as the print pixel.

However, if it is determined that the cumulative print pixel number Y_{X} exceeds a predetermined threshold value in step S106 (YES in step S106), the noise processing unit 203 advances the process to step S107.

Here, the fact that the cumulative print pixel number Y_{X} exceeds a predetermined threshold value means that it is highly possible that the pixel position x is located at the end of the data to be printed (print data) such as “which character string” shown in FIG. 3.

Therefore, as the cumulative print pixel number Y_{X} exceeds a predetermined threshold value, and the process advances to step S107, the noise processing unit 203 determines a print start position (the boundary position of the print range) based on the pixel position x determined in step S102 (step S107). Specifically, the noise processing unit 203 determines as the print start position the position shifted in the reverse direction to the main scanning direction by a predetermined margin (e.g., 10 pixels) from the pixel position x where the cumulative print pixel number Y_{X} exceeds a predetermined threshold value as shown in FIG. 5.

The noise processing unit 203 stores the print start position determined in step S107 in a memory (such as the RAM 132) and terminates the present flow.

While, in the aforementioned process, the left end of the print range is determined, the noise processing unit 203 may determine the right end of the print range through the same process. In this case, the noise processing unit 203 calculates the cumulative print pixel number Y_{X} for each pixel position x by shifting the position x of the pixel to be accumulated in the reverse direction to the main scanning direction from the position (x=1) of the pixel located in the right end of the band (the pixel scheduled to be printed in the right end of the print medium). As a result, the print start position of the right side (the boundary position of the print range) is determined based on the position where the cumulative print pixel number Y_{X} exceeds a predetermined threshold value.

Through the aforementioned process, the noise processing unit 203 according to an embodiment of the invention can determine (modify) the boundary position (both the left and right ends) of the print range. In addition, when the print pixel number N_{X} at the pixel position x is zero, since the cumulative print pixel number Y_{X} is reduced (Y_{X}=Y_{X-1}−α), it is highly possible that noise data concentrated on a portion is not printed. Therefore, it is possible to remove noise with a higher precision compared to the related art.

FIG. 6 is a schematic diagram illustrating a print operation when the image data where noise is removed through the aforementioned process is printed. The noise processing unit 203 according to an embodiment of the invention does not print the noise data (the black spots enclosed by dotted lines) concentrated in a portion as shown in the drawing. Therefore, the print head performs scanning such that only the print range (the black stained portion) is printed. Therefore, it is possible to effectively perform the operation of the print head using the image processing apparatus 100 according to an embodiment of the invention in comparison with the related art. As a result, it is possible to perform the print operation at a high speed.

Each of the processes of the aforementioned flow is divided depending on their main processing function in order to facilitate understanding of the image processing apparatus 100. The invention is not limited by a classification method of the processing steps or names thereof. The process performed by the image processing apparatus 100 may be divided into more processing steps. In addition, a single processing step may be executed by more processing steps.

### Second Embodiment

Hereinafter, another exemplary embodiment different from the first embodiment described above will be described with reference to the accompanying drawings.

The image processing apparatus 100 according to the present embodiment has the same hardware configuration and function as those of the first embodiment.

The second embodiment is different from the first embodiment in a method of creating the cumulative histogram (how to calculate the cumulative print pixel number Y_{X}).

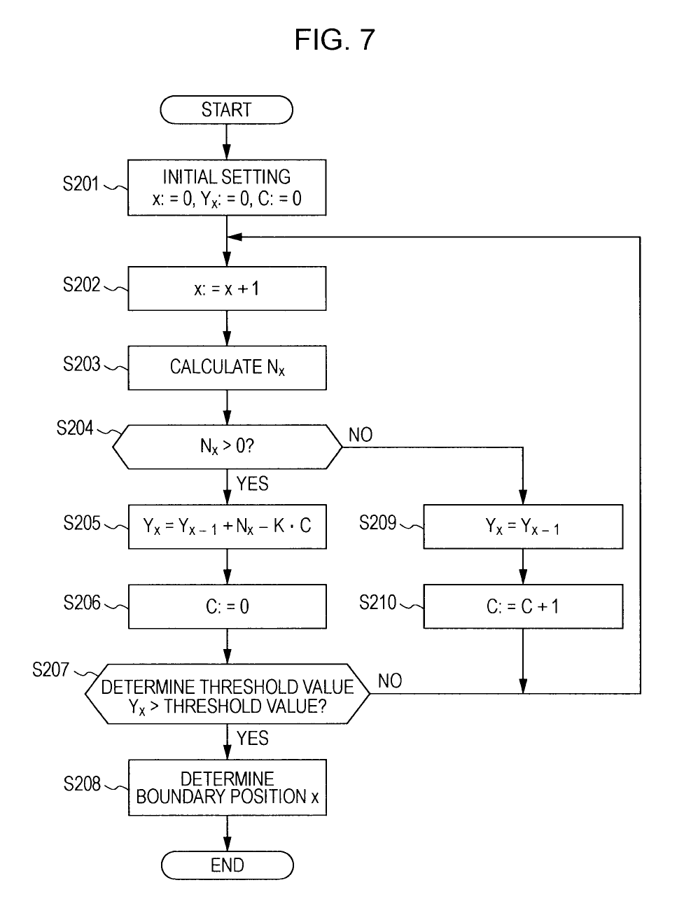

FIG. 7 is a flowchart illustrating a noise removal process according to an embodiment of the invention.

Similar to the first embodiment, the noise processing unit 203 initiates the present flow, for example, as the process in the filtering unit 202 for the image data read from the image reading unit 201 is terminated.

As the present flow is initiated, the noise processing unit 203 performs an initial setting (step S201). Specifically, the noise processing unit 203 reads the image data of the target band, the upper band, and the lower band from a memory (e.g., the RAM 132). Then, the noise processing unit 203 sets the cumulative print pixel number to an initial value (Y_{X}=0) by using the position of the target pixel for counting (accumulating) the print pixels (the pixels having a luminance value equal to or smaller than a predetermined value) as the initial position (x=0). In addition, the noise processing unit 203 sets a value for counting the number of consecutive pixel positions x having no print pixel (hereinafter, referred to as “non-cumulative number count value) as the initial value (C=0).

Then, the noise processing unit 203 shifts by one the pixel position x to be accumulated in the main scanning direction (e.g., the forward direction to the main scanning direction) (step S202). Specifically, the noise processing unit 203 performs the same process as that of step S102 of the first embodiment.

The noise processing unit 203 calculates the print pixel number N_{X} existing in the pixel position x for the image data corresponding to the three bands (the target band, the upper band, and the lower band) (step S203). Specifically, the noise processing unit 203 performs the same process as that of step S103 of the first embodiment.

Then, the noise processing unit 203 determines whether or not the print pixel number N_{X} calculated in step S203 is larger than 0 (step S204).

If it is determined in step S204 that the print pixel number N_{X} calculated in step S203 is larger than 0 (YES in step S204), the noise processing unit 203 advances the process to step S205.

As the process advances to step S205, the noise processing unit 203 adds the print pixel number N_{X} calculated in step S203 to the cumulative print pixel number Y_{X-1} (the cumulative value of the pixel positions from 1 to x−1) at that time point. Furthermore, the noise processing unit 203 subtracts, from the value obtained after the addition, a value obtained by multiplying a predetermined coefficient K by the non-cumulative number count value C at that time point, and sets the resultant value as the cumulative print pixel number Y_{X} at the pixel position x (step S205). That is, the noise processing unit 203 performs calculation of the equation “Y_{X}=Y_{X-1}+N_{X}−K·C.”

Then, the noise processing unit 203 sets the non-cumulative number count value C as the initial value (C=0) (step S206). This is because it is determined in step S204 that there is a print pixel in the pixel position x, and the pixel position x (the area) having no print pixel intermediately stops (becomes non-consecutive).

The noise processing unit 203 determines a threshold value for the cumulative print pixel number Y_{X} accumulated from the left end of the band to the pixel position x (step S207). Specifically, the noise processing unit 203 determines whether or not the cumulative print pixel number Y_{X} calculated in step S205 exceeds a predetermined threshold value.

Here, if the cumulative print pixel number Y_{X} does not exceed a predetermined threshold value (NO in step S207), the noise processing unit 203 returns the process to step S202, and repeatedly performs the process of steps S202 to S207 and steps S209, and S210 until the cumulative print pixel number Y_{X} exceeds a predetermined threshold value.

Meanwhile, if it is determined in step S204 that there is no print pixel number N_{X} calculated in step S203 (N_{X}=0) (NO in step S204), the noise processing unit 203 advances the process to step S209.

As the process advances to step S209, the noise processing unit 203 sets the cumulative print pixel number Y_{X-1} (the cumulative value accumulated from the pixel position 1 to the pixel position x−1) at that time point as the cumulative print pixel number Y_{X} of the pixel position x without change (step S209). That is, the noise processing unit 203 performs calculation of the equation “Y_{X}=Y_{X-1}.”

Subsequently, the noise processing unit 203 increments the non-cumulative time count value C (step S210). As a result, it is possible to count the number of consecutive pixel positions x having no print pixel.

Then, returning the process to step S202, the noise processing unit 203 repeatedly performs the process of steps S202 to S207 and steps S209 and S210 until the cumulative print pixel number Y_{X} exceeds a predetermined threshold value.

Then, it is possible to create the aforementioned cumulative histogram by repeating the process of steps S202 to S207 and steps S209 and S210 and calculating the cumulative print pixel number Y_{X} for each pixel position x.

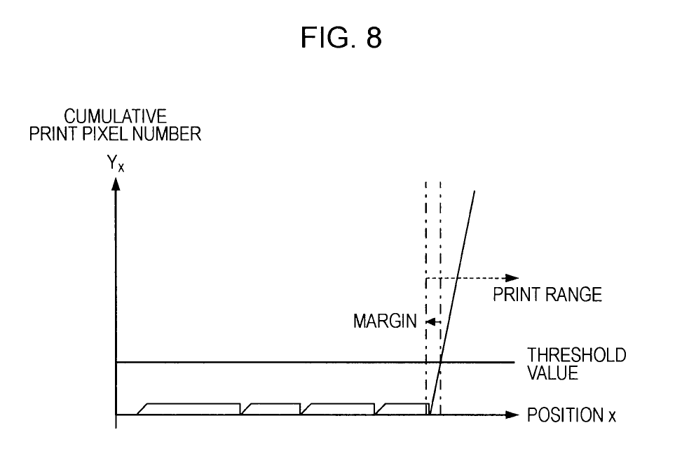

FIG. 8 illustrates a cumulative histogram created by the noise processing unit 203 according to an embodiment of the invention. In the cumulative histogram shown in the drawing, the abscissa denotes the pixel position x, and the ordinate denotes the cumulative print pixel number Y_{X}(cumulative value). As recognized from the example illustrated in the drawing, as the pixel position x increases, the cumulative print pixel number Y_{X} does not proportionally increase (it is not an ever-increasing graph), but the cumulative print pixel number Y_{X} repeatedly increases and decreases. This is because, in step S205, a value proportional to the number of consecutive pixel positions x having no print pixel is subtracted from the cumulative print pixel number Y_{X} (Y_{X}=Y_{X-1}+N_{X}−K·C). As a result, as the number of consecutive pixel positions x having no print pixel increases, the print data near that area may be regarded as noise data and may not be accumulated as the print pixel.

However, if it is determined in step S207 that the cumulative print pixel number Y_{X} exceeds a predetermined threshold value (YES in step S207), the noise processing unit 203 advances the process to step S208.

Here, a fact that the cumulative print pixel number Y_{X} exceeds a predetermined threshold value means that it is highly possible that the pixel position x is located at the end of the print data such as “which character string” in FIG. 3.

Therefore, if the cumulative print pixel number Y_{X} exceeds a predetermined threshold value, and the process advances to step S208, the noise processing unit 203 determines the print start position (the boundary position of the print range) based on the pixel position x determined in step S202 (step S208). Specifically, the noise processing unit 203 determines, as the print start position, the position obtained by shifting the cumulative print pixel number Y_{X} by a predetermined margin (e.g., 10 pixels) from the pixel position x where the cumulative print pixel number Y_{X} exceeds a predetermined threshold value in the reverse direction to the main scanning direction as shown in FIG. 8.

The noise processing unit 203 stores the print start position determined in step S208 in a memory (e.g., RAM 132) and terminates the present flow.

While, in the aforementioned process, the left end of the print range is determined, the noise processing unit 203 may determine the right end of the print range through the same processing. In this case, the noise processing unit 203 calculates the cumulative print pixel number Y_{X} for each pixel position x by shifting the position x of the pixel to be accumulated in the reverse direction to the main scanning direction from the position (x=1) of the pixel located in the right end of the band (the pixel scheduled to be printed in the right end of the print medium). As a result, the print start position of the right side (the boundary position of the print range) is determined based on the position where the cumulative print pixel number Y_{X} exceeds a predetermined threshold value.

Through the aforementioned process, the noise processing unit 203 according to an embodiment of the invention can determine (modify) the boundary position (both the left and right ends) of the print range. In addition, when the print pixel number N_{X} exists at the pixel position x, since a value proportional to the number of the consecutive pixel positions x having no print pixel is subtracted (Y_{X}=Y_{X-1}+N_{X}−K·C), it is highly possible that noise data concentrated on a portion is not printed. Therefore, it is possible to remove noise with a higher precision compared to the related art.

Each of the processes of the aforementioned flow is divided depending on their main processing function in order to facilitate understanding of the image processing apparatus 100. The invention is not limited by a classification method of the processing steps or names thereof. The process performed by the image processing apparatus 100 may be divided into more processing steps. In addition, a single processing step may be executed by more processing steps.

In addition, the invention may be variously modified or changed without limiting it to the aforementioned embodiments.

For example, in each of the aforementioned embodiments, the process of removing noise is performed using three bands of image data. However, the invention is not limited thereto. The noise processing unit 203 may perform the process of removing noise using a smaller number of bands (e.g., a single band) or a larger number of bands (e.g., 5 bands) of image data than three bands.

In the first embodiment described above, when the print pixel number N_{X} of the pixel position x is zero, the noise processing unit 203 subtracts a predetermined value α from the cumulative print pixel number Y_{X} in step S108 (Y_{X}=Y_{X-1}−α). As a modified example thereof, according to the invention, in the case where the pixel position x exceeds a predetermined value, the value α subtracted from the cumulative print pixel number Y_{X} in step S108 may increase by regarding the print data as text data. In other words, in the case where the range from the position of the band end (the end of the print medium) to the print start position exceeds a predetermined range, the value α subtracted from the cumulative print pixel number Y_{X} in step S108 increases.

In addition, according to the invention, in the case where the pixel position x does not exceed a predetermined value, the value α subtracted from the cumulative print pixel number Y_{X} in step S108 may decrease by regarding the print data as the data to be printed in the entire sheet such as a photograph. In other words, in the case where the range from the position of the band end (the end of the print medium) to the print start position does not reach a predetermined range, the value α subtracted from the cumulative print pixel number Y_{X} in step S108 decreases.

According to the second embodiment described above, the noise processing unit 203 subtracts the value proportional to the number of consecutive pixel positions x having no print pixel from the cumulative print pixel number Y_{X}(Y_{X}=Y_{X-1}+N_{X}−K·C) in step S205. As a modification thereof, in the case where the pixel position x exceeds a predetermined value, the coefficient K of the value K·C subtracted from the cumulative print pixel number Y_{X} in step S205 may increase by regarding the print data as text data. In other words, in the case where the range from the position of the band end (the end of the print medium) to the print start position exceeds a predetermined range, the coefficient K of the value K·C subtracted from the cumulative print pixel number Y_{X} in step S205 increases.

In addition, according to the invention, in the case where the pixel position x does not exceed a predetermined value, the coefficient K of the value K·C subtracted from the cumulative print pixel number Y_{X} in step S205 may decrease by regarding the print data as the data to be printed on the entire sheet such as a photograph. In other words, in the case where the range from the position of the band end (the end of the print medium) to the print start position does not reach a predetermined range, the coefficient K of the value K·C subtracted from the cumulative print pixel number Y_{X} in step S205 decreases.

What is claimed is:

1. An image processing apparatus comprising:
a reading unit that reads image data;
a counting unit that counts a number of pixels having a luminance equal to or smaller than a predetermined luminance value at each position in a main scanning direction for the image data of a predetermined number of bands read by the reading unit;
a cumulative value calculation unit that accumulates the number of pixels counted by the counting unit at each position of the main scanning direction;
a cumulative value storing unit that stores the cumulative value accumulated by the cumulative value calculation unit; and
a print range determination unit that determines a print start position based on a position where the cumulative value exceeds a predetermined threshold value,
wherein the cumulative value calculation unit sets a value obtained by subtracting a predetermined value from the cumulative value, as the cumulative value, in the case where the number of pixels having a luminance equal to or smaller than a predetermined luminance value is not counted by the counting unit.

2. The image processing apparatus according to claim 1, wherein the cumulative value calculation unit increases the predetermined value used in subtraction in the case where the range from an end of a print medium to a print start position determined by the print range determination unit exceeds a predetermined range.

3. The image processing apparatus according to claim 1, wherein the cumulative value calculation unit decreases the predetermined value used in subtraction in the case where the range from an end of a print medium to a print start position determined by the print range determination unit does not meet a predetermined range.

4. An image processing method in an image processing apparatus, the image processing method comprising:
reading image data;
counting a number of pixels having a luminance equal to or smaller than a predetermined luminance value at each position of a main scanning direction for the image data of a predetermined number of bands read in the step of reading;
calculating a cumulative value obtained by accumulating the number of pixels counted in the step of counting at each position of the main scanning direction;
storing the cumulative value accumulated in the step of calculating the cumulative value; and
determining a print start position based on the position where the cumulative value exceeds a predetermined threshold value,
wherein, in the step of calculating the cumulative value, a value obtained by subtracting a predetermined value from the cumulative value is used as the cumulative value in the case where images having a luminance value equal to or smaller than a predetermined luminance value are not counted in the step of counting.

5. A medium recording a program, when executed in a computer, configured to perform a method comprising:
reading image data;
counting a number of pixels having a luminance equal to or smaller than a predetermined luminance value at each position of a main scanning direction for the image data of a predetermined number of bands read in the step of reading;
calculating a cumulative value obtained by accumulating the number of pixels counted in the step of counting at each position of the main scanning direction;
storing the cumulative value accumulated in the step of calculating the cumulative value; and
determining a print start position based on the position where the cumulative value exceeds a predetermined threshold value,
wherein, in the step of calculating the cumulative value, a value obtained by subtracting a predetermined value from the cumulative value is used as the cumulative value in the case where images having a luminance value equal to or smaller than a predetermined luminance value are not counted in the step of counting.
